(19) United States
(12) Patent Application Publication
(10) Pub. No.: US 2026/0016672 A1
(43) Pub. Date: Jan. 15, 2026

(54) OPTICAL DETECTION STRUCTURES, PROBE SYSTEMS THAT INCLUDE OPTICAL DETECTION STRUCTURES, AND RELATED METHODS

(71) Applicant: FormFactor, Inc., Livermore, CA (US)

(72) Inventors: Kazuki Negishi, Ushiku City (JP); Quan Yuan, Dublin, CA (US); Eric Robert Christenson, Tualatin, OR (US)

(21) Appl. No.: 19/251,186

(22) Filed: Jun. 26, 2025

Related U.S. Application Data
(60) Provisional application No. 63/669,575, filed on Jul. 10, 2024.

(51) Int. Cl. G02B 21/00; G02B 21/36

(52) U.S. Cl. CPC G02B 21/0032; G02B 21/368

(57) ABSTRACT

Optical detection structures, probe systems that include the optical detection structures, and related methods are disclosed herein. The optical detection structures include a laser light source, an optical directional coupler, an optical detector, an optical fiber, and a lens assembly. The probe systems include a probe assembly, a chuck, and the optical detection structures. The methods include methods of determining when an objective lens of a lens assembly of an optical detection structure is positioned an objective focal length from a substrate surface of a substrate. The methods of mapping a surface topography of a substrate surface of a substrate.

### RELATED APPLICATION

This application claims priority to U.S. Provisional Patent Application No. 63/669,575, which was filed on Jul. 10, 2024, and the complete disclosure of which is hereby incorporated by reference.

### FIELD OF THE DISCLOSURE

The present disclosure relates generally to optical detection structures, to probe systems that include the optical detection structures, and to related methods.

### BACKGROUND OF THE DISCLOSURE

For certain applications, it may be desirable to accurately and reproducibly determine when an objective lens is positioned a focal length from a surface. Stated differently, it may be desirable to accurately and/or reproducibly focus the objective lens on the surface. As an example, it may be desirable to focus a microscope, which includes the objective lens, on the surface quickly and efficiently. As another example, probe systems, which utilize a plurality of probes to test a device under test, commonly utilize microscope focus as a baseline distance parameter from which other adjustments and/or measurements, such as positioning the probes relative to the device under test, are performed.

In conventional microscopes, positioning a conventional objective lens the focal length from the surface generally is accomplished simply by focusing the microscope on the surface. While effective in certain circumstances, this methodology may not permit positioning to the desired resolution due to the depth of field of the microscope's objective lens, which causes the surface to be in focus to the microscope over a range of distances that are within the depth of field.

As an example, silicon photonics applications generally require that corresponding probes be positioned relative to the device under test at a resolution that exceeds the capabilities of conventional microscopes. Thus, there exists a need for improved optical detection structures, for improved probe systems that include the optical detection structures, and/or for related methods.

### SUMMARY OF THE DISCLOSURE

Optical detection structures, probe systems that include the optical detection structures, and related methods are disclosed herein. The optical detection structures include a laser light source, an optical directional coupler, an optical detector, an optical fiber, and a lens assembly. The laser light source may be configured to produce a source laser beam. The optical directional coupler may include an input port, an output port, and a coupled port. The input port may be in optical communication with the laser light source and/or may be configured to receive the source laser beam. The optical detector may be in optical communication with the coupled port. The optical fiber may be in optical communication with the output port and/or may be configured to receive the source laser beam from the optical directional coupler. The optical fiber may define a transverse fiber surface that may be oriented along an emitted beam path. The optical fiber may be configured to emit the source laser beam from the transverse fiber surface as an emitted laser beam and/or along the emitted beam path. The lens assembly may be positioned along the emitted beam path and/or may be configured to receive the emitted laser beam. The lens assembly may include an objective lens configured to focus the emitted laser beam on a substrate surface of a substrate. The substrate surface may be configured to reflect the emitted laser beam as a reflected laser beam. The lens assembly may be configured to receive the reflected laser beam and/or to focus the reflected laser beam on the transverse fiber surface. The transverse fiber surface may be configured to receive the reflected laser beam as a received laser beam. The optical fiber may be configured to provide the received laser beam to the output port. The optical directional coupler may be configured to provide the received laser beam to the optical detector via the coupled port.

The probe systems include a probe assembly, a chuck, and the optical detection structure. The probe assembly may be configured to at least one of provide a test signal to a device under test that is formed on a substrate and receive a resultant signal from the device under test. The chuck may define a support surface configured to support the substrate. The probe system may be programmed to utilize the optical detection structure to determine when the objective lens is positioned a focal length from the substrate.

In some examples, the methods include methods of determining when an objective lens of a lens assembly of an optical detection structure is positioned an objective focal length from a substrate surface of a substrate. Such methods include illuminating the substrate and, during the illuminating, selectively varying a distance between the objective lens and the substrate surface. The illuminating may include illuminating the substrate with a source laser beam. This may include emitting the source laser beam from a transverse fiber surface of an optical fiber, focusing the source laser beam on the substrate surface utilizing the lens assembly, reflecting the source laser beam from the substrate surface as a reflected laser beam, receiving the reflected laser beam with the lens assembly, focusing the reflected laser beam on the transverse fiber surface utilizing the lens assembly, receiving the reflected laser beam into the optical fiber via the transverse fiber surface, and/or detecting a detected intensity of the reflected laser beam received into the optical fiber.

In some examples, the methods include methods of mapping a surface topography of a substrate surface of a substrate. Such methods include providing an intensity relationship, positioning an objective lens, illuminating the substrate surface, moving the objective lens and the substrate surface relative to one another, collecting intensity data, and calculating a relative surface height. The providing the intensity relationship may include providing an intensity relationship that correlates detected intensity to distance between the objective lens and the substrate surface. The positioning the objective lens may include positioning the objective lens an average mapping distance from the substrate surface. The illuminating the substrate surface may include illuminating the substrate surface via the objective lens, illuminating the substrate surface with a source laser beam, and/or reflecting the source laser beam from the substrate surface as a reflected laser beam. The moving the objective lens and the substrate surface relative to one another may be performed during the illuminating and/or may include moving the objective lens and the substrate surface relative to one another to scan the source laser beam across the substrate surface. The collecting intensity data may be performed responsive to the moving and/or may include collecting intensity data indicative of a detected intensity of the reflected laser beam as a function of position of the source laser beam on the substrate surface. The calculating the relative surface height May include calculating for each position of the source laser beam on the substrate surface and/or may be based, at least in part, on the intensity data and/or the intensity relationship.

### BRIEF DESCRIPTION OF THE DRAWINGS

FIG. 1 is a schematic illustration of examples of optical detection structures that may be included in microscopes and/or probe systems, according to the present disclosure.

FIG. 2 is an illustration of a more specific example of an optical detection structure according to the present disclosure.

FIG. 3 is an illustration of a more specific example of an optical detection structure according to the present disclosure.

FIG. 4 is an illustration of a more specific example of a microscope that includes an optical detection structure, according to the present disclosure.

FIG. 5 is plot illustrating an example of intensity as a function of distance between an objective lens and a substrate surface that may be generated utilizing an optical detection structure according to the present disclosure.

FIG. 6 is a more detailed view of a region of the plot of FIG. 5.

FIG. 7 is a plot illustrating attenuation as a function of offset distance for an optical detection structure, according to the present disclosure, when a wavelength of an emitted laser beam is 405 nanometers.

FIG. 8 is a plot illustrating attenuation as a function of offset distance for an optical detection structure, according to the present disclosure, when the wavelength of the emitted laser beam is 650 nanometers.

FIG. 9 is a flowchart illustrating examples of methods, according to the present disclosure, of determining when an objective lens of a lens assembly of an optical detection structure is positioned a focal length from a substrate surface of a substrate.

FIG. 10 is a flowchart illustrating examples of methods, according to the present disclosure. of mapping a surface topography of a substrate surface of a substrate.

FIG. 11 is a schematic illustration of mapping a surface topography of a substrate surface of a substrate, according to the present disclosure.

### DETAILED DESCRIPTION AND BEST MODE OF THE DISCLOSURE

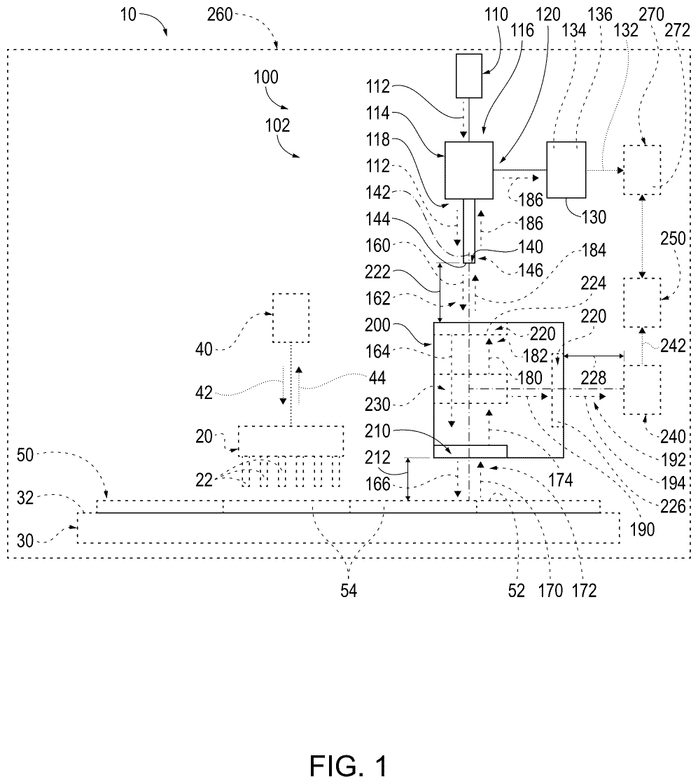

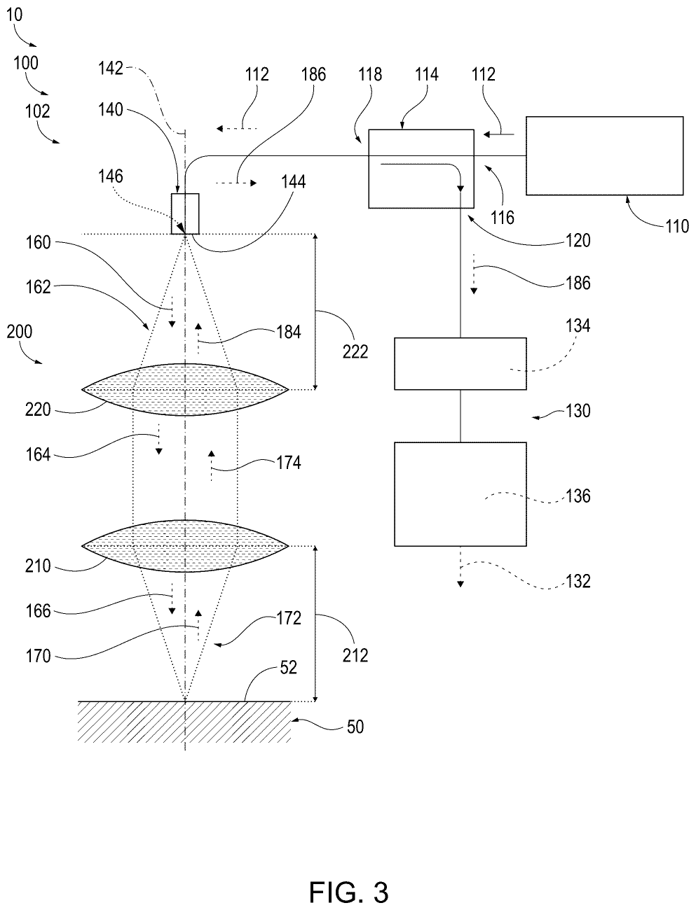

FIGS. 1-11 provide examples of probe systems 10, microscopes 100, optical detection structures 102, and/or methods 300/400, according to the present disclosure. Elements that serve a similar, or at least substantially similar, purpose are labeled with like numbers in each of FIGS. 1-11, and these elements may not be discussed in detail herein with reference to each of FIGS. 1-11. Similarly, all elements may not be labeled in each of FIGS. 1-11, but reference numerals associated therewith may be utilized herein for consistency. Elements, components, functions, and/or features that are discussed herein with reference to one or more of FIGS. 1-11 may be included in and/or utilized with any of FIGS. 1-11 without departing from the scope of the present disclosure.

In general, elements that are likely to be included in a particular embodiment are illustrated in solid lines, while elements that may be optional are illustrated in dashed lines. However, elements that are shown in solid lines may not be essential to all embodiments and, in some embodiments, may be omitted without departing from the scope of the present disclosure.

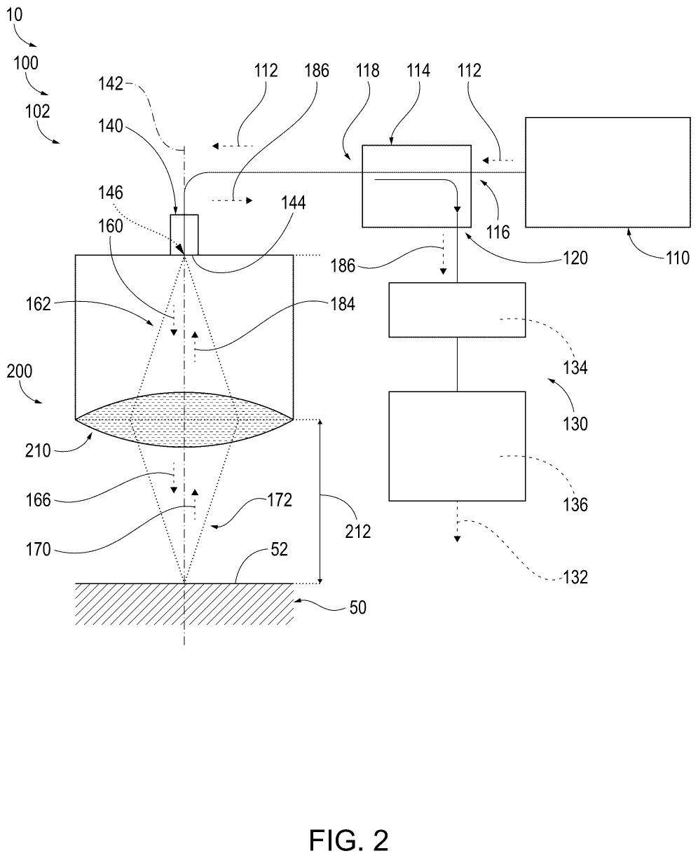

FIG. 1 is a schematic illustration of examples of optical detection structures 102 that may be included in microscopes 100, such as optical microscopes, and/or probe systems 10, according to the present disclosure. FIGS. 2-4 are illustrations of more specific examples of optical detection structure 102 according to the present disclosure, such as optical detection structures 102 that are included in and/or utilized with probe systems 10 and/or microscopes 100 of FIG. 1. As collectively illustrated in FIGS. 1-4, optical detection structures 102 include a laser light source 110 and an optical directional coupler 114. Optical directional coupler 114 includes an input port 116, an output port 118, and a coupled port 120. Input port 116 is in optical communication with the laser light source. Optical detection structures 102 also include an optical detector 130, which is in optical communication with coupled port 120, and an optical fiber 140, which is in optical communication with output port 118. Optical fiber 140 includes and/or defines a transverse fiber surface 144 that is oriented along an emitted beam path 162. Optical detection structures 102 further include a lens assembly 200, which is positioned along emitted beam path 162. The lens assembly includes an objective lens 210.

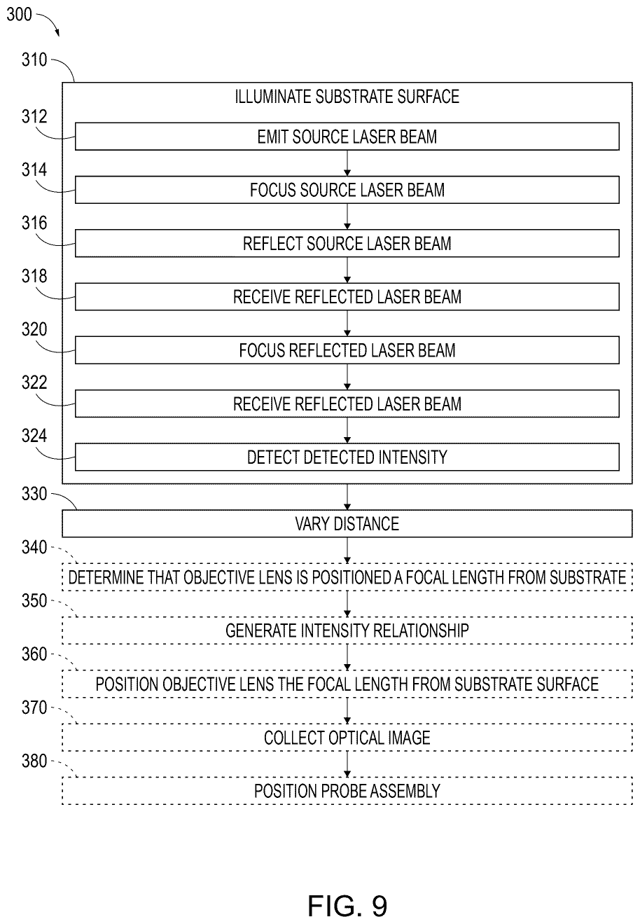

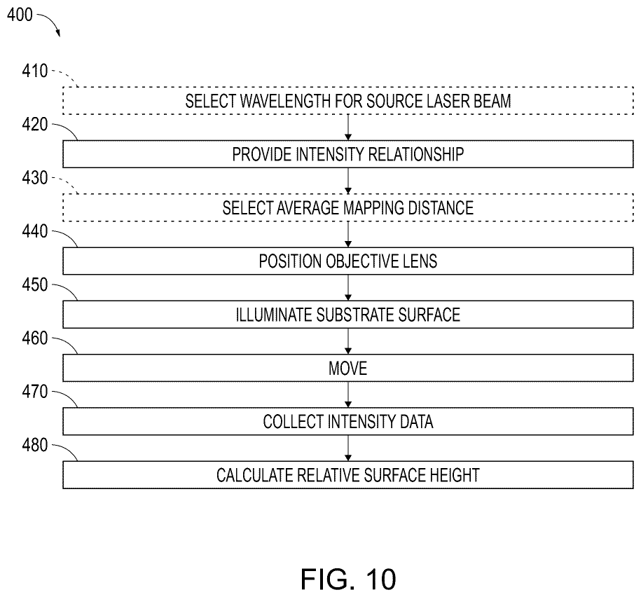

During operative use of optical detection structures 102, and as discussed in more detail herein with reference to methods 300 and 400 of FIGS. 9-10, laser light source 110 may produce and/or emit a source laser beam 112, which may be received by input port 116 of optical directional coupler 114. Optical directional coupler 114 may convey the source laser beam to output port 118, which may provide the source laser beam to optical fiber 140. Optical fiber 140 may emit source laser beam 112 from transverse fiber surface 144 and along emitted beam path 162 as an emitted laser beam 160. Lens assembly 200 may receive emitted laser beam 160 and may focus the emitted laser beam onto a substrate surface 52 of a substrate 50. This may include focusing the emitted laser beam onto the substrate surface as a focused emitted laser beam 166.

Substrate surface 52 may reflect the emitted laser beam as a reflected laser beam 170, and lens assembly 200 may receive the reflected laser beam and focus the reflected laser beam onto transverse fiber surface 144 of optical fiber 140, which may function as a pinhole structure. This may include focusing the reflected laser beam onto the transverse fiber surface as a focused reflected laser beam 184. Optical fiber 140 then may receive the reflected laser beam as a received laser beam 186 and/or may provide the received laser beam to output port 118 of optical directional coupler 114. The optical directional coupler then may provide the received laser beam to optical detector 130 via coupled port 120. Responsive to receipt of received laser beam 186, optical detector 130 may produce and/or generate an intensity output 132, which may be based upon and/or indicative of an intensity of received laser beam 186.

Optical detection structures 102 are configured such that the intensity of received laser beam 186, and thus the value of intensity output 132, is dependent upon the distance between objective lens 210 of lens assembly 200 and substrate surface 52. More specifically, the intensity of the received laser beam is maximized, or is at a maximum value, when the distance between the objective lens and the substrate surface is equal to an objective focal length 212 of the objective lens. In addition, the intensity of the received laser beam decreases substantially when the distance between the objective lens and the substrate surface differs from the objective focal length, including when differing only by a small amount.

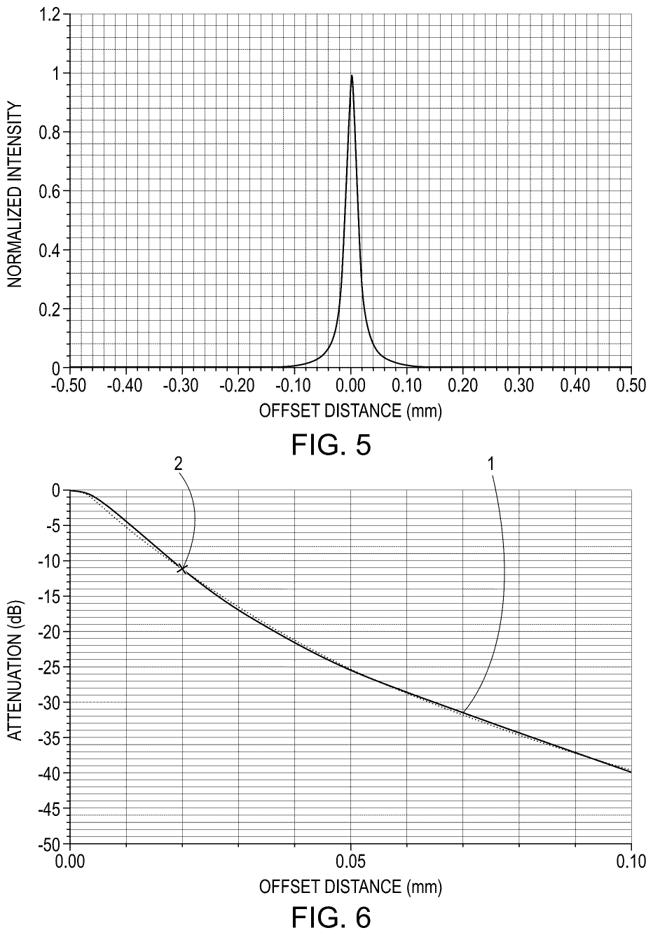

With this in mind, and as discussed in more detail herein, the distance between the objective lens and the substrate surface may be varied, and the intensity of the received laser beam concurrently may be detected. FIG. 5 is a plot illustrating an example of intensity of the received laser beam as a function of distance between the objective lens and the substrate surface that may be generated utilizing optical detection structure 102. In particular, FIG. 5 plots normalized intensity (normalized from the maximum detected intensity) on the ordinate (or Y-axis) as a function of offset distance from the objective focal length (in millimeters) on the abscissa (or X-axis). As illustrated in FIG. 5, the detected intensity is maximized when the offset distance is zero (i.e., when the distance between the objective lens and the substrate surface is equal to the objective focal length). As also illustrated in FIG. 5, the detected intensity quickly falls to a value of approximately 1% of the maximum value when the offset distance is ±0.10 millimeters (mm).

FIG. 6 is a more detailed view of a region of FIG. 5 and illustrates attenuation from maximum intensity (in decibels) on the ordinate and offset distance on the abscissa. As may be seen from FIG. 6, the detected intensity falls by an order of magnitude (i.e., 10 dB) at an offset distance of only 0.02 mm (20 micrometers). FIG. 6 also illustrates that the functional behavior of attenuation with respect to offset distance readily may be approximated by a polynomial curve fit, as indicated by the dotted line in FIG. 6. Given the illustrated sensitivity of attenuation to offset distance, optical detection structures 102 generally permit and/or facilitate accurate and repeatable positioning of the objective lens at the objective focal length from the substrate with a resolution on the order of 1.0 to 1.5 micrometers. This is in distinct contrast to conventional microscopes, which only are capable of providing accurate and repeatable positioning of the objective lens at the objective focal length from the substrate with a resolution on the order of 10's of micrometers (utilizing, for example, a 10× objective lens).

In addition to the above-described increase in positioning resolution, optical detection structures 102 provide other benefits over conventional microscopes. As an example, and because a conventional microscope relies upon establishing a focused image to determine when the objective lens is positioned the objective focal length from the substrate, any automation of this focusing routine must rely heavily upon pattern recognition software to recognize when a collected optical image is in focus. This pattern recognition software requires significant computing resources and slows the overall focusing process. In contrast, the objective lens may be positioned the objective focal length from the substrate simply via maximizing detected intensity when optical detection structure 102 is utilized. This process is simpler and requires less computing power when compared to conventional microscopes, thereby decreasing the cost and increasing the speed of automated focusing routines that are performed utilizing optical detection structure 102 relative to conventional microscopes.

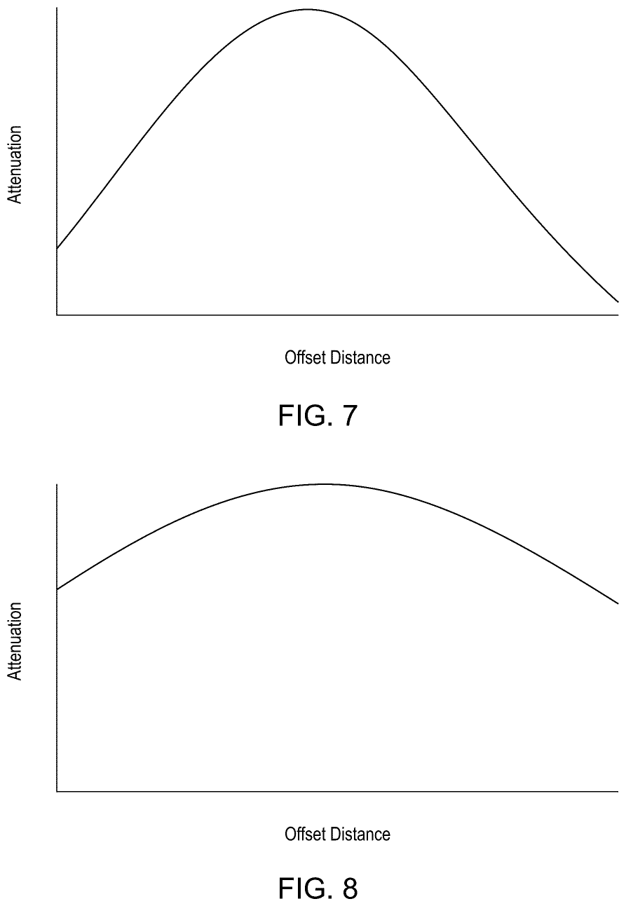

As another example, a sensitivity of optical detection structure 102 to the offset distance readily may be adjusted for a given configuration of lens assembly 200, thereby permitting and/or facilitating detection of the offset distance over a relatively broader, or narrower, distance range depending upon a desired detection resolution. Such a benefit simply is not available to conventional microscopes that are focused in a conventional manner. In particular, variation of a wavelength of emitted laser beam 160, such as via variation in a wavelength of source laser beam 112, may be utilized to selectively vary the sensitivity. FIG. 7 illustrates attenuation as a function of offset distance when the wavelength of the emitted laser beam is 405 nanometers (nm), while FIG. 8 illustrates attenuation as a function of offset distance over the same scales but when the wavelength of the emitted laser beam is 650 nm. As may be seen, the sensitivity to the offset distance, as well as the magnitude of the offset distance that readily may be detected, changes significantly with the wavelength of the emitted laser beam. In particular, the sensitivity of the offset distance decreases with increases in the wavelength of the emitted laser beam, and the sensitivity of the offset distances increases with decreases in the wavelength of the emitted laser beam. Concurrently, the magnitude of the offset distance that readily may be detected increases with increases in the wavelength of the emitted laser beam, and the magnitude of the offset distances that readily may be detected decreases with decreases in the wavelength of the emitted laser beam.

Laser light source 110 may include any suitable structure that may be adapted, configured, designed, and/or constructed to produce and/or generate source laser beam 112 and/or to provide the source laser beam to input port 116 of optical directional coupler 114. Examples of laser light source 110 include a monochromatic, or at least substantially monochromatic, laser light source, a visible light source, a violet-colored laser light source, and/or a red-colored laser light source. In some examples, utilization of a laser light source 110 that produces visible light may be beneficial, such as via permitting an operator of the optical detection structure to visibly see the laser beam on substrate surface 52. Additionally or alternatively, and in some examples, utilization of a laser light source 110 that produces light outside the visible spectrum may be beneficial, such as when substrate 50 and/or devices on substrate 50 that are detected by the optical detection structure are sensitive to, or may be damaged by, visible light.

Another example of laser light source 110 includes a laser light source configured to selectively produce the source laser beam at a plurality of distinct, or discrete, wavelengths, such as at least 2, at least 3, or at least 4 distinct, or discrete, wavelengths. In some such examples, laser light source 110 may include a plurality of distinct, or discrete, laser light sources, each configured to generate laser light at a corresponding wavelength. In some such examples, laser light source 110 further may include a wavelength combiner, which may be configured to combine source laser beam 112 from each laser light source to produce a combined laser beam and/or to provide the combined laser beam to optical directional coupler 114.

An additional example of laser light source 110 includes a laser light source that produces source laser beam 112 with a wavelength of at least 380 nm, at least 400 nm, at least 420 nm, at least 440 nm, at least 460 nm, at least 480 nm, at least 500 nm, at least 520 nm, at least 540 nm, at least 560 nm, at least 580 nm, at least 600 nm, at least 620 nm, at least 640 nm, at least 660 nm, at least 680 nm, at most 700 nm, at most 680 nm, at most 660 nm, at most 640 nm, at most 620 nm, at most 600 nm, at most 580 nm, at most 560 nm, at most 540 nm, at most 520 nm, at most 500 nm, at most 480 nm, at most 460 nm, at most 440 nm, at most 420 nm, or at most 400 nm.

Laser light source 110 may produce source laser beam 112 with any suitable intensity and/or may have any suitable power output, or maximum power output. As examples, the power output of laser light source 110 may be at least 0.1 milliWatts (mW), at least 0.5 mW, at most 5 mW, at most 4 mW, at most 3 mW, at most 2 mW, at most 1 mW, or at most 0.5 mW.

Optical directional coupler 114 may include any suitable structure that includes input port 116, that includes output port 118, that includes coupled port 120, that is configured to receive source laser beam 112 from laser light source 110, that is configured to convey source laser beam 112 from input port 116 to output port 118, that is configured to provide source laser beam 112 to optical fiber 140, that is configured to convey received laser beam 186 from output port 118 to coupled port 120, that is configured to provide received laser beam 186 to optical detector 130, and/or that is configured to split the received laser beam from the source laser beam. As an example, optical directional coupler 114 may include, or be, an optical splitter.

Optical detector 130 may include and/or be any suitable structure that may be adapted, configured, designed, and/or constructed to be in optical communication with coupled port 120 of optical directional coupler 114, to receive received laser beam 186 from the optical directional coupler, and/or to produce intensity output 132 responsive to receipt of the received laser beam. An example of optical detector 130 includes, or is, a photodiode 134. Another example of optical detector 130 includes an analog signal processor 136. Examples of analog signal processor 136 include an amplifier, a log amplifier, and/or a log compressed amplifier.

As another example, and when laser light source 110 includes the plurality of distinct, or discrete, laser light sources, optical detector 130 may include a plurality of wavelength pass filters, each of which may be configured to permit a corresponding wavelength of light to pass therethrough, a plurality of photodetectors, each of which may be configured to receive laser light from a corresponding wavelength pass filter, and/or a plurality of analog signal processors, each of which may be configured to receive a corresponding signal from a corresponding photodetector.

Optical fiber 140 may include any suitable structure that may be in optical communication with output port 118 of optical directional coupler 114, that defines transverse fiber surface 144, that is configured to receive the source laser beam from the output port, that is configured to convey the source laser beam from the output port to the transverse fiber surface, that is configured to emit emitted laser beam 160 from the transverse fiber surface, that is configured to receive reflected laser beam 170 via the transverse fiber surface as received laser beam 186, and/or that is configured to convey the received laser beam from the transverse fiber surface to the output port of the optical directional coupler. As an example, optical fiber 140 may include, or be, a fiber optic cable.

Transverse fiber surface 144 may extend perpendicular, or at least substantially perpendicular, to emitted beam path 162 and/or to a transmission axis 142 of the optical fiber at the transverse fiber surface. In some examples, optical fiber 140 and/or transverse fiber surface 144 thereof may include, be, and/or define a pinhole structure 146 for reflected laser beam 170 that is incident thereon. Such a configuration may exclude a fraction of the reflected laser beam that is not focused, or precisely focused, on the transverse fiber surface from entry into and/or conveyance through the optical fiber.

As illustrated in dashed lines in FIG. 1, optical detection structure 102 may include and/or may be utilized with a translation structure 260. Translation structure 260 may be configured to move, to translate, and/or to rotate one or more components of optical detection structure 102, of microscopes 100 that include the optical detection structure, and/or of probe systems 10 that include the optical detection structure in any suitable manner and/or for any suitable purpose. As an example, translation structure 260 may be configured to operatively translate objective lens 210 and substrate surface 52 relative to one another. This may include translation of the objective lens, of the substrate, and/or of the substrate surface in and/or along a direction that is parallel, or at least substantially parallel, to a region of the emitted beam path 162 that extends between the objective lens and the substrate surface. Examples of translation structure 260 include a rack and pinion assembly, a lead screw and nut assembly, a ball screw and nut assembly, a motor, a servo motor, a stepper motor, a linear actuator, a rotary actuator, and/or a piezoelectric actuator.

As also illustrated in dashed lines in FIG. 1, optical detection structures 102 may include a controller 270. Controller 270 may be adapted, configured, designed, and/or programmed to control the operation of at least one other component of optical detection structure 102. As an example, controller 270 may be programmed to control the operation of optical detection structure 102 according to any suitable step and/or steps of methods 300 and/or 400, which are discussed in more detail herein. As a more specific example, controller 270 may be programmed to control the operation of laser light source 110, such as to cause the laser light source to produce the source laser beam. As another more specific example, controller 270 may be programmed to control the operation of translation structure 260, such as to cause the translation structure to operatively translate the objective lens and the substrate surface relative to one another and/or in the direction that is parallel to the region of the emitted beam path that extends between the objective lens and the substrate surface. As yet another more specific example, controller 270 may be in communication with optical detector 130 and/or may be programmed to determine and/or identify a relative orientation between the objective lens and the substrate surface at which the intensity of the received laser beam is at the maximum value.

Controller 270 may include and/or be any suitable structure, device, and/or devices that may be adapted, configured, designed, constructed, and/or programmed to perform the functions discussed herein. As examples, controller 270 may include one or more of an electronic controller, a dedicated controller, a special-purpose controller, a personal computer, a special-purpose computer, a display device, a logic device, a memory device, and/or a memory device having computer-readable storage media.

The computer-readable storage media, when present, also may be referred to herein as non-transitory computer readable storage media 272. This non-transitory computer readable storage media may include, define, house, and/or store computer-executable instructions, programs, and/or code; and these computer-executable instructions may direct probe system 10 and/or controller 270 thereof to perform any suitable portion, or subset, of methods 300 and/or 400. Examples of such non-transitory computer-readable storage media include CD-ROMs, disks, hard drives, flash memory, etc. As used herein, storage, or memory, devices and/or media having computer-executable instructions, as well as computer-implemented methods and other methods according to the present disclosure, are considered to be within the scope of subject matter deemed patentable in accordance with Section 101 of Title 35 of the United States Code.

Returning more generally to FIGS. 1-4, lens assembly 200 may include any suitable structure that may be positioned along emitted beam path 162, that may include objective lens 210, that may be configured to receive emitted laser beam 160 from optical fiber 140, that may be configured to focus the emitted laser beam onto substrate surface 52, that may be configured to receive reflected laser beam 170, and/or that may be configured to focus the reflected laser beam on transverse fiber surface 144 of the optical fiber. As discussed, objective lens 210 has and/or defines objective focal length 212, such as via a material of construction, a shape, and/or a size of the objective lens. Stated differently, lens assembly 200 and/or objective lens 210 thereof may be configured to focus emitted laser beam 160 at objective focal length 212.

As illustrated in FIGS. 1-2, and with specific reference to FIG. 2, lens assembly 200 may, in some examples, define and/or be a finite optical system or a finite-corrected optical system. In such a configuration, emitted beam path 162 of emitted laser beam 160 and/or a reflected beam path 172 of reflected laser beam 170 may include, only may include, may extend through, and/or only may extend through a single lens in the form of objective lens 210. Such a configuration may permit and/or facilitate construction of relatively compact and/or economical optical detection structures 102.

Alternatively, as illustrated in FIGS. 1 and 3-4, lens assembly 200 may, in some examples, define and/or be an infinity-corrected optical system. In such a configuration, emitted beam path 162 of emitted laser beam 160 and/or reflected beam path 172 of reflected laser beam 170 may include and/or may extend through a plurality of lenses that include both objective lens 210 and a tube lens 220. In such a configuration, tube lens 220 may define a tube focal length 222, and transverse fiber surface 144 may be positioned, or permanently may be positioned, the tube focal length from the tube lens.

Tube lens 220 may be configured to receive emitted laser beam 160 and to provide the emitted laser beam to objective lens 210 as a collimated emitted laser beam 164. Objective lens 210 may be configured to receive collimated emitted laser beam 164 and to focus the collimated emitted laser beam onto substrate surface 52 as focused emitted laser beam 166. Similarly, objective lens 210 may be configured to receive reflected laser beam 170 and to provide the reflected laser beam to tube lens 220 as a collimated reflected laser beam 174. Tube lens 220 may be configured to receive the collimated reflected laser beam and to focus the collimated reflected laser beam onto transverse fiber surface 144 as focused reflected laser beam 184.

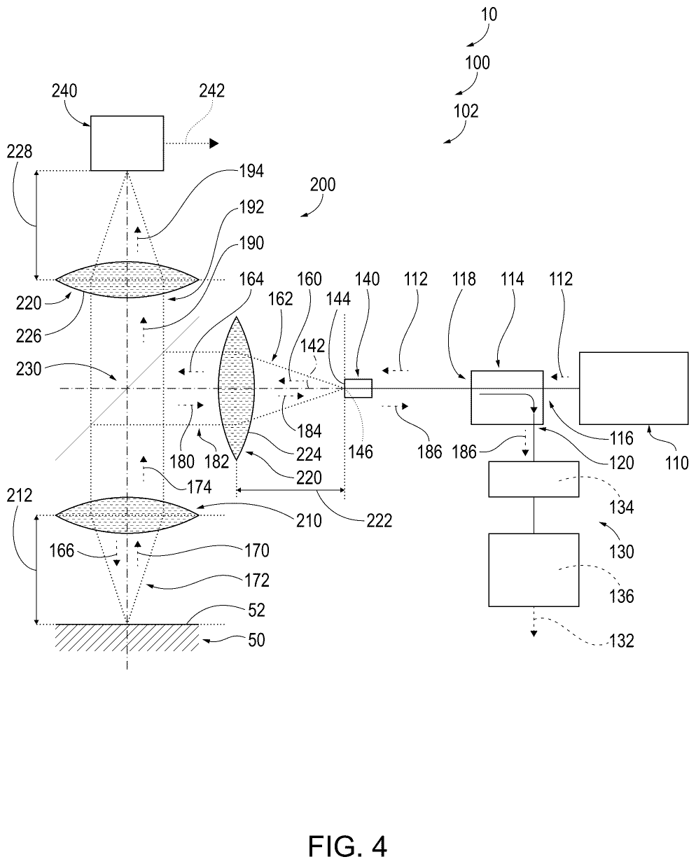

As illustrated in FIGS. 1 and 4, optical detection structures 102, according to the present disclosure, may be incorporated into, may form a portion of, and/or may be utilized with microscopes 100. As an example, lens assembly 200 may include a beam splitter 230, which may be positioned between tube lens 220 and objective lens 210 and/or which may be positioned along reflected beam path 172 of reflected laser beam 170. Examples of beam splitter 230 include a half mirror and/or a prism.

Beam splitter 230 may be configured to split collimated reflected laser beam 174 into a collimated detection beam 180 and a collimated imaging beam 190. Collimated detection beam 180 may propagate along a detection reflected beam path 182 that may be colinear, or at least substantially colinear, with the emitted beam path 162. Collimated imaging beam 190 may propagate along an imaging reflected beam path 192 that partially differs from the emitted beam path.

In such examples, lens assembly 200 may include a plurality of tube lenses 220, including a detection tube lens 224 and an imaging tube lens 226. In such a configuration, tube focal length 222 may be referred to herein as a detection tube lens focal length 222, and imaging tube lens 226 may define an imaging tube lens focal length 228. Also in such examples, detection tube lens 224 may be configured to receive emitted laser beam 160, to provide the emitted laser beam to objective lens 210 as collimated emitted laser beam 164, to receive the collimated reflected laser beam, and to focus the collimated reflected laser beam onto transverse fiber surface 144 as focused reflected laser beam 184. In addition, imaging tube lens 226 may be positioned along imaging reflected beam path 192, may be configured to receive collimated imaging beam 190, and/or may be configured to focus the collimated imaging beam as a focused imaging beam 194.

Also in such examples, optical detection structures 102 and/or microscopes 100 that include optical detection structures 102 may include an image sensor 240. Image sensor 240 may be configured to receive focused imaging beam 194 from imaging tube lens 226 and to generate an image sensor output 242, which may be indicative of an optical image conveyed by the focused imaging beam. Examples of image sensor 240 include a charge coupled device and an active pixel sensor.

Optical detection structures 102 and/or microscopes 100 that include the optical detection structures further may include an image display 250, as illustrated in FIG. 1. Image display 250 may be configured to receive image sensor output 242 and to display the optical image, such as to an operator of the optical detection structure. Examples of image display 250 include a monitor, a computer monitor, a liquid crystal display, a plasma display, and/or a light emitting diode display.

Turning more specifically to FIG. 1, and as discussed, optical detection structures 102 and/or microscopes 100 that include the optical detection structures may be incorporated in and/or utilized with a probe system 10. Probe systems 10 include a probe assembly 20, a chuck 30, and at least one optical detection structure 102. Probe assembly 20 includes a plurality of probes 22. Probes 22 may be configured to provide a test signal 42 to a device under test (DUT) 54 that is formed and/or defined on substrate 50. Probes 22 additionally or alternatively may be configured to receive a resultant signal 44 from the DUT. In some examples, probe assembly 20 may include and/or be an optical probe assembly. In such examples, probes 22 may include and/or be optical probes, test signal 42 may include and/or be an optical test signal, and/or resultant signal 44 may include and/or be an optical resultant signal. The optical probes may be configured for non-contact communication and/or optical communication with DUT 54, such as to permit and/or facilitate transmission of the optical test signals and/or of the optical resultant signals between the probe assembly and the DUT. Stated differently, the optical probes may be spaced apart from and/or may not touch the DUT when the optical test signal and/or the optical resultant signal is conveyed between the optical probes and the DUT.

Additionally or alternatively, and in some examples, probe assembly 20 may include and/or be an electrical probe assembly. In such examples, probes 22 may include and/or be electrical probes, test signal 42 may include and/or be an electrical test signal, and/or resultant signal 44 may include and/or be an electrical resultant signal. The electrical probes may be configured for contact, or electrical contact, with DUT 54, such as to permit and/or facilitate transmission of the electrical test signals and/or of the electrical resultant signals between the probe assembly and the DUT. Stated differently, the electrical probes may contact, may directly contact, may physically contact, and/or may electrically contact the DUT when the electrical test signal and/or the electrical resultant signal is conveyed between the electrical probes and the DUT.

As illustrated in dashed lines in FIG. 1, probe systems 10 also may include a signal generation and analysis assembly 40. Signal generation and analysis assembly 40 may be configured to produce and/or generate test signal 42, to provide the test signal to probe assembly 20, to receive resultant signal 44 from the probe assembly, and/or to analyze the resultant signal. Examples of signal generation and analysis assembly 40 include a power source, an electric power source, an AC power source, a DC power source, a function generator, an electrical signal generator, an optical signal generator, an electrical detector, an electrical signal analyzer, a voltage detector, a current detector, an impedance analyzer, an optical signal detector, and/or an optical signal analyzer.

Chuck 30 may define a support surface 32, which may be configured to support substrate 50. Examples of chuck 30 include a vacuum chuck, a temperature-controlled chuck, and/or an electrically shielded chuck.

As discussed, probe systems 10 may include translation structure 260. As also discussed, translation structure 260 may be configured to move and/or to translate optical detection structure 102, lens assembly 200, and/or objective lens 210 thereof relative to substrate surface 52. It is within the scope of the present disclosure that translation structure 260 additionally or alternatively may be configured to move, to operatively translate, and/or to operatively rotate any suitable component and/or structure of probe system 10 relative to and/or with respect to any suitable other component of the probe system. As an example, translation structure 260 may be configured to move, to translate, and/or to rotate probe assembly 20 relative to support surface 32 and/or to move, to translate, and/or to rotate the support surface relative to the probe assembly.

Substrate 50 may include and/or be any suitable structure that may define substrate surface 52 and/or that may include at least one DUT 54. Examples of substrate 50 include a wafer, a semiconductor wafer, a silicon wafer, and/or a Group III-V semiconductor wafer. Examples of DUT 54 include a semiconductor device, an electronic device, an optical device, a solid-state device, and/or an optoelectronic device.

FIG. 9 is a flowchart illustrating examples of methods 300, according to the present disclosure, of determining when an objective lens of a lens assembly of an optical detection structure is positioned an objective focal length from a substrate surface of a substrate. Examples of the objective lens, the lens assembly, the optical detection structure, the objective focal length, the substrate surface, and the substrate are disclosed herein with reference to objective lens 210, lens assembly 200, optical detection structure 102, objective focal length 212, substrate surface 52, and substrate 50, respectively.

Methods 300 include illuminating a substrate surface at 310 and varying a distance at 330. Methods 300 also may include determining that an objective lens is positioned the objective focal length from the substrate at 340, generating an intensity relationship at 350, positioning the objective lens the objective focal length from the substrate at 360, collecting an optical image at 370, and/or positioning a probe assembly at 380.

Illuminating the substrate surface at 310 may include illuminating the substrate surface with a source laser beam. The illuminating at 310 may be performed in any suitable manner. As examples, the illuminating at 310 may include emitting the source laser beam at 312, focusing the source laser beam at 314, reflecting the source laser beam at 316, and/or receiving a reflected laser beam at 318. The illuminating at 310 further may include focusing the reflected laser beam at 320, receiving the reflected laser beam at 322, and/or detecting a detected intensity at 324.

Emitting the source laser beam at 312 may include emitting the source laser beam from a transverse fiber surface of an optical fiber and/or emitting the source laser beam as an emitted laser beam. This may include initiating emission of the source laser beam from a laser light source and/or providing the source laser beam to the optical fiber from the laser light source. In more specific examples, the emitting at 312 may include providing the source laser beam to an input port of an optical directional coupler and/or providing the source laser beam to the optical fiber via an output port of the optical directional coupler. Examples of the source laser beam, the transverse fiber surface, and the optical fiber are disclosed herein with reference to source laser beam 112, transverse fiber surface 144, and optical fiber 140, respectively. Examples of the laser light source are disclosed herein with reference to laser light source 110. Examples of the optical directional coupler, the input port, and the output port are disclosed herein with reference to optical directional coupler 114, input port 116, and output port 118, respectively.

Focusing the source laser beam at 314 may include focusing the source laser beam on the substrate surface and/or focusing the source laser beam as a focused emitted laser beam. This may include focusing any suitable fraction and/or subset of the source laser beam on the substrate surface and may be performed with, via, and/or utilizing the lens assembly, such as via the objective lens thereof. The focusing at 314 may be performed subsequent to, at least partially concurrently with, and/or responsive to the emitting at 312.

Reflecting the source laser beam at 316 may include reflecting the source laser beam from the substrate surface. This may include reflecting any suitable fraction and/or subset of the source laser beam as a reflected laser beam. The reflecting at 316 may be performed subsequent to, at least partially concurrently with, and/or responsive to the focusing at 314.

Receiving the reflected laser beam at 318 may include receiving the reflected laser beam with the lens assembly. This may include receiving any suitable fraction and/or subset of the reflected laser beam with the lens assembly and/or conveying the fraction and/or subset of the reflected laser beam through the lens assembly. The receiving at 318 may be performed subsequent to, at least partially concurrently with, and/or responsive to the reflecting at 316.

Focusing the reflected laser beam at 320 may include focusing the reflected laser beam on the transverse fiber surface and/or may include focusing the reflected laser beam as a focused reflected laser beam. This may include focusing the reflected laser beam with, via, and/or utilizing the lens assembly. Additionally or alternatively, the focusing at 320 may include focusing any suitable fraction and/or subset of the reflected laser beam, such as the fraction and/or subset received during the receiving at 318. The focusing at 320 may be performed subsequent to, at least partially concurrently with, and/or responsive to the receiving at 318.

Receiving the reflected laser beam at 322 may include receiving the reflected laser beam into the optical fiber and/or receiving the reflected laser beam as a received laser beam. This may include receiving the reflected laser beam into the optical fiber with, via, and/or through the transverse fiber surface. Additionally or alternatively, the receiving at 322 may include receiving any suitable fraction and/or subset of the reflected laser beam as the received laser beam. As discussed in more detail herein, the optical fiber and/or the transverse fiber surface may form and/or define a pinhole structure. As such, the receiving at 322 may include excluding a fraction of the reflected laser beam that is not focused, or precisely focused, on the transverse fiber surface from entry into and/or conveyance through the optical fiber. The receiving at 322 may be performed subsequent to, at least partially concurrently with, and/or responsive to the focusing at 320.

Detecting the detected intensity at 324 may include detecting the detected intensity of the reflected laser beam. This may include detecting the detected intensity of any suitable fraction and/or subset of the reflected laser beam that is received into the fiber optic cable during the receiving at 322, such as of the received laser beam. In specific examples, the detecting at 324 may include conveying the reflected laser beam through the optical fiber, to the output port of the optical directional coupler, to a coupled port of the optical directional coupler, and from the coupled port to an optical detector that performs the detecting at 324. Examples of the coupled port and of the optical detector are disclosed herein with reference to coupled port 120 and optical detector 130, respectively. The detecting at 324 may be performed subsequent to, at least partially concurrently with, and/or responsive to the receiving at 322.

Varying the distance at 330 may include selectively varying a distance between the objective lens and the substrate surface. This may include varying the distance in and/or along a direction that is perpendicular, or at least substantially perpendicular, to the transverse fiber surface, that is perpendicular, or at least substantially perpendicular, to the substrate surface, and/or that is parallel, or at least substantially parallel, to an emitted beam path of the source laser beam at the transverse fiber surface. Examples of the emitted beam path are disclosed herein with reference to emitted beam path 162. In specific examples, the varying at 330 may be performed with, via, and/or utilizing a translation structure, examples of which are disclosed herein with reference to translation structure 260. The varying at 330 may be performed during, at least partially concurrently with, or completely concurrently with the illuminating at 310 and/or any suitable step and/or steps thereof.

Determining that the objective lens is positioned the objective focal length from the substrate at 340 may include determining that the objective lens is positioned the objective focal length from the substrate when, or responsive to, the detected intensity being maximized. Stated differently, and as discussed in more detail herein with reference to FIGS. 5-8, the detected intensity may vary with the distance between the objective lens and the substrate surface and may have and/or exhibit a maximum value (i.e., be maximized) when the distance between the objective lens and the substrate surface is equal to the objective focal length. As such, the distance between the objective lens and the substrate surface at which the detected intensity has and/or exhibits the maximum value corresponds to, or equals, the objective focal length of the objective lens. Stated differently, detection of a local and/or global maxima in detected intensity as a function of the distance between the objective lens and the substrate surface is indicative of the distance being equal to the objective focal length. The determining at 340 may be performed during, concurrently with, responsive to, and/or subsequent to the varying at 330.

Generating the intensity relationship at 350 may include generating any suitable relationship that correlates the detected intensity to and/or describes the detected intensity as a function of the (relative and/or absolute) distance between the objective lens and the substrate surface, the relative orientation between the objective lens and the substrate, and/or the offset distance of the objective lens relative to the objective focal length. Examples of the intensity relationship include a plot that correlates detected intensity to distance between the objective lens and the substrate surface, a database that includes a plurality of detected intensity values and a corresponding plurality of distances between the objective lens and the substrate surface, and/or a mathematical relationship that correlates detected intensity to the distance between the objective lens and the substrate surface. The generating at 350 may be performed subsequent to, at least partially concurrently with, and/or responsive to the varying at 330.

Positioning the objective lens the objective focal length from the substrate surface at 360 may include moving the substrate, the lens assembly, and/or the objective lens such that the distance between the objective lens and the substrate surface is equal to the objective focal length. This may include moving with, via, and/or utilizing the translation structure and/or moving the objective lens to a distance, relative to the substrate, at which the detected intensity, as detected during the detecting at 324, is maximized and/or exhibits a maximum value. The positioning at 360 may be performed subsequent and/or responsive to the varying at 330, the determining at 340, and/or the generating at 350.

Collecting the optical image at 370 may include collecting an optical image of the substrate surface via and/or utilizing the objective lens. As an example, and as discussed in more detail herein, the optical detection structure may form a portion of a microscope, examples of which are disclosed herein with reference to microscope 100. In such examples, the microscope may utilize the objective lens to collect the optical image and/or the collecting at 370 may be performed utilizing the microscope. The collecting at 370 may be performed subsequent and/or responsive to the positioning at 360.

Positioning the probe assembly at 380 may include positioning any suitable probe assembly of a probe system for communication with a device under test that is formed on the substrate. Examples of the probe assembly, the probe system, and the device under test are disclosed herein with reference to probe assembly 20, probe system 10, and device under test 54, respectively. The positioning at 380 may be performed in any suitable manner. As an example, the positioning at 380 may be based, at least in part, on the determining at 340. As a more specific example, the determining at 340 may be utilized to establish a baseline and/or known distance between the objective lens and the substrate surface (i.e., the objective focal length), a distance between a probe of the probe assembly and the objective lens also may be known and/or predetermined, and methods 300 may utilize this information to permit and/or facilitate the positioning at 380. As another example, the positioning at 380 may be based, at least in part, on the collecting at 370. As a more specific example, the optical image, which is collected during the collecting at 370, may provide visual information that may be utilized to permit and/or facilitate the positioning at 380.

FIG. 10 is a flowchart illustrating examples of methods 400, according to the present disclosure, of mapping a surface topography of a substrate surface of a substrate. Examples of the substrate surface and the substrate are disclosed herein with reference to substrate surface 52 and substrate 50, respectively.

Methods 400 may include selecting a wavelength for a source laser beam at 410, include providing an intensity relationship at 420, and may include selecting an average mapping distance at 430. Methods 400 also include positioning an objective lens at 440, illuminating the substrate surface at 450, moving at 460, collecting intensity data at 470, and calculating a relative surface height at 480. Examples of the source laser beam and the objective lens are disclosed herein with reference to source laser beam 112 and objective lens 210, respectively.

Selecting the wavelength for the source laser beam at 410 may include selecting the wavelength of the source laser beam based, at least in part, on an expected surface height range for the substrate surface. This may be performed in any suitable manner. As an example, and as discussed in more detail herein with reference to FIGS. 7-8, a sensitivity of a detected intensity of a reflected laser beam, which is detected by the optical detection structure, to distance between the objective lens and the substrate surface may vary with the wavelength of the source laser beam. Additionally or alternatively, a distance range over which the distance between the objective lens and the substrate surface may be quantified by the optical detection structure may vary with the wavelength of the source laser beam. Accordingly, the selecting at 410 may be utilized to configure the optical detection structure to detect variations in the surface topography of the substrate surface over the expected surface height range for the substrate surface. This may include selecting a relatively longer wavelength for the source laser beam when the expected surface height range is relatively larger. Alternatively, this may include selecting a relatively shorter wavelength for the source laser beam when the expected surface height range is relatively smaller.

In some examples, the selecting at 410 may include selecting an identity and/or a specification for a single laser light source for the source laser beam. In some examples, and as discussed in more detail herein with reference to FIG. 1, a plurality of laser light sources may be utilized. In some such examples, the selecting at 410 may include selecting from among the plurality of laser light sources.

Providing the intensity relationship at 420 may include providing, obtaining, and/or establishing any suitable intensity relationship that describes the detected intensity as a function of distance between the objective lens and the substrate surface. In general, the providing at 420 includes performing any suitable step and/or steps of methods 300, and in particular the generating at 350, to produce and/or generate the intensity relationship. However, this is not required of all examples, and it is within the scope of the present disclosure that the providing at 420 additionally or alternatively may include obtaining a premeasured, predetermined, and/or pre-established intensity relationship.

Selecting the average mapping distance at 430 may include selecting the average mapping distance to be utilized during the positioning at 440. The selecting at 430 may be performed in any suitable manner. As an example, the selecting at 430 may include selecting the average mapping distance based, at least in part, on the intensity relationship. As a more specific example, the selecting at 430 may include selecting such that the detected intensity, at the average mapping distance, is a fraction of a maximum value of the detected intensity in the intensity relationship. Such a configuration may provide sensitivity to detect both increases and decreases in the distance between the objective lens and the substrate surface that are experienced during the moving at 460 and/or caused by variations in the surface topography of the substrate surface. Examples of the fraction of the maximum value include at least 10%, at least 20%, at least 30%, at least 40%, at least 50%, at least 60%, at least 70%, at least 80%, at most 90%, at most 80%, at most 70%, at most 60%, at most 50%, at most 40%, and/or at most 30%.

Positioning the objective lens at 440 may include positioning the objective lens the average mapping distance from the substrate surface. This may be performed in any suitable manner. As an example, the positioning at 440 may include moving the objective lens and/or the substrate surface toward and/or away from one another to establish the average mapping distance therebetween. As another example, the positioning at 440 may be performed with, via, and/or utilizing a translation structure, examples of which are disclosed herein with reference to translation structure 260. As yet another example, the positioning at 440 may include performing the illuminating at 450 while moving the objective lens and/or the substrate surface toward and/or away from one another until the detected intensity is equal to the fraction of the maximum value of the detected intensity in the intensity relationship that was selected during the selecting at 430.

Illuminating the substrate surface at 450 may include illuminating the substrate surface with a source laser beam. This may include performing any suitable step and/or steps of methods 300 and/or of the illuminating at 310, examples of which are disclosed herein.

Moving at 460 may include moving the objective lens and the substrate surface relative to one another and may be performed during and/or concurrently with the illuminating at 450. This may include moving the objective lens and/or moving the substrate surface to scan, or to raster scan, the source laser beam across the substrate surface. The moving at 460 may be performed in any suitable manner. As an example, the moving at 460 may be performed with, via, and/or utilizing the translation structure.

As used herein, the phrase “average mapping distance” refers to a distance between the objective lens and an average height of the substrate surface. Stated differently, and due to the surface topography of the substrate surface, the actual distance between the objective lens and the substrate surface will vary during the moving at 460. However, the moving at 460 is performed within a plane that is perpendicular, or at least substantially perpendicular, to a beam path of the source laser beam between the objective lens and the substrate surface and/or that is parallel, or at least substantially parallel, to the substrate surface. As such, the average mapping distance between the objective lens and the substrate surface is constant, or at least substantially constant, during the moving at 460. Stated differently, the moving at 460 may be performed without varying the average mapping distance and/or while maintaining a fixed, or at least substantially fixed, average mapping distance.

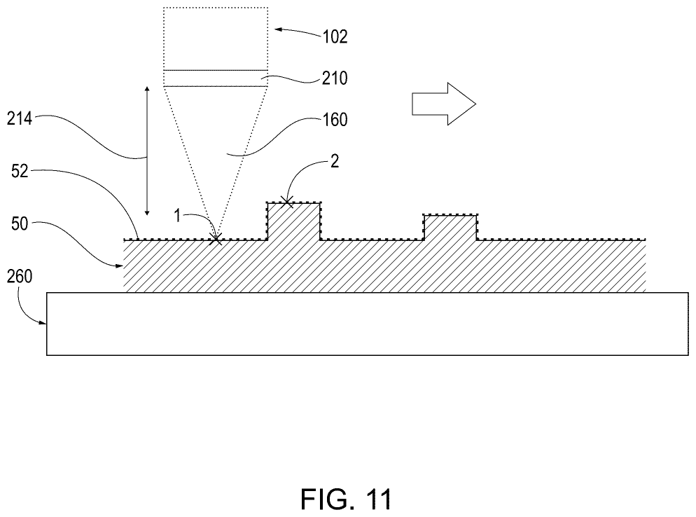

An example of the moving at 460 is illustrated in FIG. 11. In the example of FIG. 11, objective lens 210 of optical detection structure 102 is positioned average mapping distance 214 from substrate surface 52 of substrate 50, such as during the positioning at 440. Subsequently, the moving at 460 is performed to move substrate surface 52 relative to objective lens 210, such as in the direction indicated by the horizontal arrow in FIG. 11, utilizing translation structure 260.

Collecting intensity data at 470 may include collecting intensity data indicative of detected intensity as a function of position of the source laser beam on the substrate surface. This may be performed in any suitable manner. As an example, the collecting at 470 may be performed as part of the illuminating at 450, such as via performing the detecting at 324 that is discussed in more detail herein with reference to methods 300 of FIG. 9. The collecting at 470 may be performed at least partially concurrently with, responsive to, and/or as a result of the moving at 460. In some examples, the collecting at 470 may include generating an intensity database that includes a plurality of detected intensities and a corresponding plurality of positions of the source laser beam on and/or in the plane of the substrate surface.

Calculating the relative surface height at 480 may include calculating the relative surface height for each position of the source laser beam on the substrate surface. The calculating at 480 may be performed in any suitable manner. As an example, the calculating at 480 may include calculating the relative surface height utilizing and/or based, at least in part, on the intensity relationship. As a more specific example, the calculating the relative surface height may include determining, from the intensity relationship, a distance between the objective lens and the substrate surface that corresponds to the detected intensity for each position of the source laser beam on the substrate surface. As an example, and during the collecting at 470, the intensity data may be collected at a plurality of different locations along the substrate surface, including location 1 and location 2 as indicated in FIG. 11. The intensity data at location 1 may, for example, be indicated at 1 in FIG. 6, and the intensity data at location 2 may be indicated at 2 in FIG. 6. From the curve that is illustrated in FIG. 6 and/or from the polynomial curve fit to that curve, relative surface heights at locations 1 and 2 in FIG. 11 may be calculated. This process may be repeated for every location on the substrate surface for which intensity data is collected during the collecting at 470, thereby permitting mapping of the substrate surface in two or three dimensions.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of optical detection structures, microscopes, probe systems, and methods according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.

A1. An optical detection structure, comprising:
a laser light source;
an optical directional coupler that includes an input port, an output port, and a coupled port; wherein the input port is in optical communication with the laser light source;
an optical detector in optical communication with the coupled port;
an optical fiber in optical communication with the output port, wherein the optical fiber defines a transverse fiber surface that is oriented along an emitted beam path; and
a lens assembly positioned along the emitted beam path, wherein the lens assembly includes an objective lens;
wherein at least one of:
(i) the laser light source is configured to produce a source laser beam;
(ii) the input port is configured to receive the source laser beam from the laser light source;
(iii) the output port is configured to provide the source laser beam to the optical fiber;
(iv) the optical fiber is configured to emit the source laser beam from the transverse fiber surface as an emitted laser beam and along the emitted beam path;
(v) the lens assembly is configured to receive the emitted laser beam and to focus the emitted laser beam onto a substrate surface of a substrate;
(vi) the substrate surface is configured to reflect the emitted laser beam as a reflected laser beam;
(vii) the lens assembly is configured to receive the reflected laser beam and to focus the reflected laser beam on the transverse fiber surface;
(viii) the transverse fiber surface is configured to receive the reflected laser beam as a received laser beam;
(ix) the optical fiber is configured to provide the received laser beam to the output port; and
(x) the optical directional coupler is configured to provide the received laser beam to the optical detector via the coupled port.

A2. The optical detection structure of paragraph A1, wherein the laser light source includes, or is, at least one of:
(i) a monochromatic, or at least substantially monochromatic, laser light source;
(ii) a visible light source;
(iii) a red-colored laser light source;
(iv) a violet-colored laser light source; and
(v) a laser light source that produces light outside the visible spectrum.

A3. The optical detection structure of any of paragraphs A1-A2, wherein at least one of:
(i) the laser light source is configured to selectively produce the source laser beam at a plurality of distinct wavelengths; and
(ii) the optical detection structure includes a plurality of laser light sources, each of which is configured to generate a corresponding source laser beam at a corresponding wavelength.

A4. The optical detection structure of any of paragraphs A1-A3, wherein the laser light source has a power of at least 0.1 milliWatts (mW), at least 0.5 mW, at most 5 mW, at most 4 mW, at most 3 mW, at most 2 mW, at most 1 mW, or at most 0.5 mW.

A5. The optical detection structure of any of paragraphs A1-A4, wherein the optical directional coupler includes, is, or instead is an optical splitter.

A6. The optical detection structure of any of paragraphs A1-A5, wherein the optical directional coupler is configured to split the received laser beam from the source laser beam.

A7. The optical detection structure of any of paragraphs A1-A6, wherein, responsive to receipt of the received laser beam, the optical detector is configured to generate an intensity output indicative of an intensity of the received laser beam.

A8. The optical detection structure of any of paragraphs A1-A7, wherein the optical detector includes, or is, a photodiode.

A9. The optical detection structure of any of paragraphs A1-A8, wherein the optical detector includes an analog signal processor.

A10. The optical detection structure of any of paragraphs A1-A9, wherein the transverse fiber surface extends perpendicular, or at least substantially perpendicular, to at least one of the emitted beam path at the transverse fiber surface and a transmission axis of the optical fiber at the transverse fiber surface.

A11. The optical detection structure of any of paragraphs A1-A10, wherein the transverse fiber surface defines a pinhole structure configured to receive the reflected laser beam.

A12. The optical detection structure of any of paragraphs A1-A11, wherein the objective lens defines an objective focal length.

A13. The optical detection structure of paragraph A12, wherein the lens assembly is configured to focus the emitted laser beam at the objective focal length.

A14. The optical detection structure of any of paragraphs A1-A13, wherein the lens assembly further includes a tube lens, wherein the tube lens is configured to receive the emitted laser beam and to provide the emitted laser beam to the objective lens as a collimated emitted laser beam.

A15. The optical detection structure of paragraph A14, wherein the objective lens is configured to receive the collimated emitted laser beam and to focus the collimated emitted laser beam onto the substrate surface as a focused emitted laser beam.

A16. The optical detection structure of any of paragraphs A14-A15, wherein the tube lens defines a tube focal length, and further wherein the transverse fiber surface is positioned the tube focal length from the tube lens.

A17. The optical detection structure of any of paragraphs A14-A16, wherein the objective lens is configured to receive the reflected laser beam and to provide the reflected laser beam to the tube lens as a collimated reflected laser beam.

A18. The optical detection structure of paragraph A17, wherein the tube lens is configured to receive the collimated reflected laser beam and to focus the collimated reflected laser beam onto the transverse fiber surface as a focused reflected laser beam.

A19. The optical detection structure of paragraph A18, wherein the lens assembly further includes a beam splitter positioned between the tube lens and the objective lens along a reflected beam path of the reflected laser beam.

A20. The optical detection structure of paragraph A19, wherein the beam splitter includes at least one of a half mirror and a prism.

A21. The optical detection structure of any of paragraphs A19-A20, wherein the beam splitter is configured to split the collimated reflected laser beam into a collimated detection beam, which propagates along a detection reflected beam path that is colinear, or at least substantially colinear, with the emitted beam path, and a collimated imaging beam, which propagates along an imaging reflected beam path that partially differs from the emitted beam path.

A22. The optical detection structure of paragraph A21, wherein the tube lens is a detection tube lens, and further wherein the lens assembly includes an imaging tube lens, which is positioned along the imaging reflected beam path and is configured to receive the collimated imaging beam and to focus the collimated imaging beam as a focused imaging beam.

A23. The optical detection structure of paragraph A22, wherein the optical detection structure further includes an image sensor configured to receive the focused imaging beam from the imaging tube lens and to generate an image sensor output indicative of an optical image conveyed by the focused imaging beam.

A24. The optical detection structure of paragraph A23, wherein the optical detection structure further includes an image display configured to display the optical image to an operator of the optical detection structure.

A25. The optical detection structure of any of paragraphs A1-A24, wherein the optical detection structure further includes a translation structure configured to operatively translate the objective lens and the substrate surface relative to one another and in a direction that is parallel to a region of the emitted beam path that extends between the objective lens and the substrate surface.

A26. The optical detection structure of any of paragraphs A1-A25, wherein the optical detection structure further includes a controller programmed to control the operation of at least one other component of the optical detection structure.

A27. The optical detection structure of paragraph A26, wherein the controller is programmed to control the operation of the optical detection structure according to any suitable step and/or steps of any of the methods of any of paragraphs C1-D10.

A28. The optical detection structure of any of paragraphs A26-A27, wherein the controller is programmed to:
(i) control the operation of the laser light source to produce the source laser beam;
(ii) control the operation of a/the translation structure to operatively translate the objective lens and the substrate surface relative to one another in a/the direction that is parallel to a/the region of the emitted beam path that extends between the objective lens and the substrate surface; and
(iii) determine a relative orientation between the objective lens and the substrate surface at which an intensity of the received laser beam is at a maximum value.

B1. A probe system, comprising;
a probe assembly configured to at least one of provide a test signal to a device under test that is formed on a substrate and receive a resultant signal from the device under test;
a chuck that defines a support surface configured to support the substrate; and
the optical detection structure of any of paragraphs A1-A28, wherein the probe system is programmed to utilize the optical detection structure to determine when the objective lens is positioned a/the focal length from the substrate.

B2. The probe system of paragraph B1, wherein the probe assembly includes, or is, an optical probe assembly, wherein the test signal includes, or is, an optical test signal, and further wherein the resultant signal includes, or is, an optical resultant signal.

B3. The probe system of any of paragraphs B1-B2, wherein the probe assembly includes, or is, an electrical probe assembly, wherein the test signal includes, or is, an electrical test signal, and further wherein the resultant signal includes, or is, an electrical resultant signal.

C1. A method of determining when an objective lens of a lens assembly of an optical detection structure is positioned an objective focal length from a substrate surface of a substrate, the method comprising:
illuminating the substrate surface with a source laser beam by:
(i) emitting the source laser beam from a transverse fiber surface of an optical fiber;
(ii) focusing the source laser beam on the substrate surface utilizing the lens assembly;
(iii) reflecting the source laser beam from the substrate surface as a reflected laser beam;
(iv) receiving the reflected laser beam with the lens assembly;
(v) focusing the reflected laser beam on the transverse fiber surface utilizing the lens assembly;
(vi) receiving the reflected laser beam into the optical fiber via the transverse fiber surface; and
(vii) detecting a detected intensity of the reflected laser beam received into the optical fiber; and
during the illuminating, selectively varying a distance between the objective lens and the substrate surface.

C2. The method of paragraph C1, wherein the method further includes determining that the objective lens is positioned the objective focal length from the substrate surface when the detected intensity is maximized.

C3. The method of paragraph C2, wherein the determining includes determining a distance that produces at least one of:
(i) a local maxima in detected intensity; and
(ii) a global maxima in detected intensity.

C4. The method of any of paragraphs C2-C3, wherein, subsequent to the determining, the method further includes positioning the objective lens the objective focal length from the substrate surface.

C5. The method of paragraph C4, wherein the method further includes collecting an optical image of the substrate surface via the objective lens.

C6. The method of any of paragraphs C2-C5, wherein the method further includes positioning a probe assembly of a probe system for communication with a device under test that is formed on the substrate, and further wherein the positioning is based, at least in part, on the determining.

C7. The method of any of paragraphs C1-C6, wherein the method further includes generating an intensity relationship that correlates detected intensity to distance between the objective lens and the substrate surface.

C8. The method of paragraph C7, wherein the intensity relationship includes at least one of:
(i) a plot that correlates detected intensity to distance between the objective lens and the substrate surface;
(ii) a database that includes a plurality of detected intensity values and a corresponding plurality of distances between the objective lens and the substrate surface; and
(iii) a mathematical relationship that correlates detected intensity to distance between the objective lens and the substrate surface.

C9. The method of any of paragraphs C1-C8, wherein the optical detection structure includes any suitable structure, function, and/or feature of any of the optical detection structures of any of paragraphs A1-A28 or any of the probe systems of any of paragraphs B1-B3.

D1. A method of mapping a surface topography of a substrate surface of a substrate, the method comprising:
providing an intensity relationship, optionally by performing the method of any of paragraphs C7-C8 to generate the intensity relationship;
positioning the objective lens an average mapping distance from the substrate surface;
illuminating the substrate surface with a/the source laser beam;
during the illuminating, moving the objective lens and the substrate surface relative to one another to scan the source laser beam across the substrate surface;
responsive to the moving, collecting intensity data indicative of the detected intensity as a function of position of the source laser beam on the substrate surface; and
calculating, for each position of the source laser beam on the substrate surface, a relative surface height, wherein the relative surface height is based, at least in part, on the intensity data and the intensity relationship.

D2. The method of paragraph D1, wherein the method further includes selecting the average mapping distance based, at least in part, on the intensity relationship.

D3. The method of paragraph D2, wherein the selecting the average mapping distance includes selecting such that the detected intensity, at the average mapping distance, is a fraction of a maximum value of the detected intensity in the intensity relationship.

D4. The method of paragraph D3, wherein the fraction is at least one of:
(i) at least 10%, at least 20%, at least 30%, at least 40%, at least 50%, at least 60%, at least 70%, or at least 80%; and
(ii) at most 90%, at most 80%, at most 70%, at most 60%, at most 50%, at most 40%, or at most 30%.

D5. The method of any of paragraphs D1-D4, wherein the moving the optical detection structure includes raster scanning the source laser beam across the substrate surface.

D6. The method of any of paragraphs D1-D5, wherein the collecting intensity data includes generating an intensity database that includes a plurality of detected intensities and a corresponding plurality of positions of the source laser beam on the substrate surface.

D7. The method of any of paragraphs D1-D6, wherein the calculating the relative surface height includes determining, from the intensity relationship, a distance between the objective lens and the substrate surface that corresponds to the detected intensity for each position of the source laser beam on the substrate surface.

D8. The method of any of paragraphs D1-D7, wherein the method includes performing the moving at least one of:
(i) without varying the average mapping distance; and
(ii) while maintaining a fixed, or at least substantially fixed, average mapping distance.

D9. The method of any of paragraphs D1-D8, wherein the method further includes selecting a wavelength for the source laser beam based, at least in part, on an expected surface height range for the substrate surface.

D10. The method of paragraph D9, wherein the method further includes at least one of:
(i) selecting a relatively longer wavelength for the source laser beam when the expected surface height range is relatively larger; and
(ii) selecting a relatively shorter wavelength for the source laser beam when the expected surface height range is relatively smaller.

E1. Non-transitory computer-readable storage media including computer-executable instructions that, when executed, direct a probe system, a microscope, and/or an optical detection structure to perform any suitable step and/or steps of any of the methods of any of paragraphs C1-D10.

### INDUSTRIAL APPLICABILITY

The optical detection structures, microscopes, and probe systems disclosed herein are applicable to the distance detection, microscopy, semiconductor manufacturing, and semiconductor test industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. An optical detection structure, comprising:
a laser light source configured to produce a source laser beam;
an optical directional coupler that includes an input port, an output port, and a coupled port;
wherein the input port is in optical communication with the laser light source and configured to receive the source laser beam;
an optical detector in optical communication with the coupled port;
an optical fiber in optical communication with the output port and configured to receive the source laser beam from the optical directional coupler, wherein the optical fiber defines a transverse fiber surface that is oriented along an emitted beam path, and further wherein the optical fiber is configured to emit the source laser beam from the transverse fiber surface as an emitted laser beam and along the emitted beam path; and
a lens assembly positioned along the emitted beam path and configured to receive the emitted laser beam, wherein the lens assembly includes an objective lens configured to focus the emitted laser beam on a substrate surface of a substrate;
wherein the substrate surface is configured to reflect the emitted laser beam as a reflected laser beam, wherein the lens assembly is configured to receive the reflected laser beam and to focus the reflected laser beam on the transverse fiber surface, wherein the transverse fiber surface is configured to receive the reflected laser beam as a received laser beam, wherein the optical fiber is configured to provide the received laser beam to the output port, and wherein the optical directional coupler is configured to provide the received laser beam to the optical detector via the coupled port.

2. The optical detection structure of claim 1, wherein the optical directional coupler is configured to split the received laser beam from the source laser beam.

3. The optical detection structure of claim 1, wherein the transverse fiber surface extends at least substantially perpendicular to at least one of the emitted beam path at the transverse fiber surface and a transmission axis of the optical fiber at the transverse fiber surface.

4. The optical detection structure of claim 1, wherein the transverse fiber surface defines a pinhole structure configured to receive the reflected laser beam.

5. The optical detection structure of claim 1, wherein the lens assembly further includes a tube lens, wherein the tube lens is configured to receive the emitted laser beam and to provide the emitted laser beam to the objective lens as a collimated emitted laser beam, wherein the objective lens is configured to receive the collimated emitted laser beam and to focus the collimated emitted laser beam onto the substrate surface as a focused emitted laser beam, wherein the objective lens is configured to receive the reflected laser beam and to provide the reflected laser beam to the tube lens as a collimated reflected laser beam, and wherein the tube lens is configured to receive the collimated reflected laser beam and to focus the collimated reflected laser beam onto the transverse fiber surface as a focused reflected laser beam.

6. The optical detection structure of claim 5, wherein the lens assembly further includes a beam splitter positioned between the tube lens and the objective lens along a reflected beam path of the reflected laser beam, wherein the beam splitter is configured to split the collimated reflected laser beam into a collimated detection beam, which propagates along a detection reflected beam path that is at least substantially colinear with the emitted beam path, and a collimated imaging beam, which propagates along an imaging reflected beam path that partially differs from the emitted beam path.

7. The optical detection structure of claim 6, wherein the tube lens is a detection tube lens, and further wherein the lens assembly includes an imaging tube lens, which is positioned along the imaging reflected beam path and is configured to receive the collimated imaging beam and to focus the collimated imaging beam as a focused imaging beam, wherein the optical detection structure further includes an image sensor configured to receive the focused imaging beam from the imaging tube lens and to generate an image sensor output indicative of an optical image conveyed by the focused imaging beam.

8. The optical detection structure of claim 7, wherein the optical detection structure further includes an image display configured to display the optical image to an operator of the optical detection structure.

9. The optical detection structure of claim 1, wherein the optical detection structure further includes a translation structure configured to operatively translate the objective lens and the substrate surface relative to one another and in a direction that is parallel to a region of the emitted beam path that extends between the objective lens and the substrate surface.

10. The optical detection structure of claim 9, wherein the optical detection structure further includes a controller programmed to:
(i) control the operation of the laser light source to produce the source laser beam;
(ii) control the operation of the translation structure to operatively translate the objective lens and the substrate surface relative to one another in the direction that is parallel to the region of the emitted beam path that extends between the objective lens and the substrate surface; and
(iii) determine a relative orientation between the objective lens and the substrate surface at which an intensity of the received laser beam is at a maximum value.

11. A probe system, comprising;
a probe assembly configured to at least one of provide a test signal to a device under test that is formed on a substrate and receive a resultant signal from the device under test;
a chuck that defines a support surface configured to support the substrate; and
the optical detection structure of claim 1, wherein the probe system is programmed to utilize the optical detection structure to determine when the objective lens is positioned a focal length from the substrate.

12. The probe system of claim 11, wherein the probe assembly includes an optical probe assembly, wherein the test signal includes an optical test signal, and further wherein the resultant signal includes an optical resultant signal.

13. The probe system of claim 11, wherein the probe assembly includes an electrical probe assembly, wherein the test signal includes an electrical test signal, and further wherein the resultant signal includes an electrical resultant signal.

14. A method of determining when an objective lens of a lens assembly of an optical detection structure is positioned an objective focal length from a substrate surface of a substrate, the method comprising:
illuminating the substrate surface with a source laser beam by:
(i) emitting the source laser beam from a transverse fiber surface of an optical fiber;
(ii) focusing the source laser beam on the substrate surface utilizing the lens assembly;
(iii) reflecting the source laser beam from the substrate surface as a reflected laser beam;
(iv) receiving the reflected laser beam with the lens assembly;
(v) focusing the reflected laser beam on the transverse fiber surface utilizing the lens assembly;
(vi) receiving the reflected laser beam into the optical fiber via the transverse fiber surface; and
(vii) detecting a detected intensity of the reflected laser beam received into the optical fiber; and
during the illuminating, selectively varying a distance between the objective lens and the substrate surface.

15. The method of claim 14, wherein the method further includes determining that the objective lens is positioned the objective focal length from the substrate surface when the detected intensity is maximized.

16. The method of claim 15, wherein, subsequent to the determining, the method further includes positioning the objective lens the objective focal length from the substrate surface.

17. The method of claim 16, wherein the method further includes collecting an optical image of the substrate surface via the objective lens.

18. The method of claim 15, wherein the method further includes positioning a probe assembly of a probe system for communication with a device under test that is formed on the substrate, and further wherein the positioning is based, at least in part, on the determining.

19. The method of claim 14, wherein the method further includes generating an intensity relationship that correlates detected intensity to distance between the objective lens and the substrate surface.

20. A method of mapping a surface topography of a substrate surface of a substrate, the method comprising:
providing an intensity relationship that correlates detected intensity to distance between an objective lens and the substrate surface;
positioning the objective lens an average mapping distance from the substrate surface;
illuminating the substrate surface via the objective lens and with a source laser beam and reflecting the source laser beam from the substrate surface as a reflected laser beam;
during the illuminating, moving the objective lens and the substrate surface relative to one another to scan the source laser beam across the substrate surface;
responsive to the moving, collecting intensity data indicative of a detected intensity of the reflected laser beam as a function of position of the source laser beam on the substrate surface; and
calculating, for each position of the source laser beam on the substrate surface, a relative surface height, wherein the relative surface height is based, at least in part, on the intensity data and the intensity relationship.
